(19) United States
(12) Patent Application Publication
(10) Pub. No.: US 2026/0153919 A1
(43) Pub. Date: Jun. 4, 2026

(54) AUTOMATICALLY TRANSITIONING FROM NON-OPERATIONAL POWER STATE TO OPERATIONAL POWER STATE BASED ON HISTORICAL DATA

(71) Applicant: International Business Machines Corporation, Armonk, NY (US)

(72) Inventors: Venkateshwar R. YERRAVALLI, Hyderabad (IN); Phani Kumar V. U. AYYAGARI, Hyderabad (IN); Yadagiri RAJABOINA, Hyderabad (IN); Hanumanthu HANOK, Hyderabad (IN); Bharath Kumar GUTHA, Anantapur (IN)

(21) Appl. No.: 18/967,635

(22) Filed: Dec. 3, 2024

(51) Int. Cl. G06F 1/3234; G06F 1/3225

(52) U.S. Cl. CPC G06F 1/3275; G06F 1/3225

(57) ABSTRACT

A host system may determine a power state schedule of a storage device, wherein the power state schedule identifies a schedule of the storage device executing operational power state commands. The host system may determine, based on the power state schedule, a period of time for the storage device to transition from a non-operational power state to an operational power state. The host system may generate transition configuration information that configures the storage device to transition from the non-operational power state to the operational power state after the storage device has been in the non-operational power state for the period of time. The host system may provide, to the storage device, the transition configuration information to configure the storage device to transition from the non-operational power state to the operational power state prior to the storage device receiving a subsequent operational power state command.

### BACKGROUND

The present invention relates to storage devices, and more for example to the field of power states of storage devices.

A storage device includes hardware components that store and retrieve data (e.g., digital information). The storage device may store data accessed by a computer data. The data may include programs, data, and instructions. In some situations, the storage device may include a flash storage device. The flash storage device may include a solid-state storage technology that uses flash memory chips for writing and storing data, known as input/output operations per second (IOPS).

### SUMMARY

In some implementations, a method includes determining a power state schedule of a storage device, wherein the power state schedule identifies a schedule of the storage device executing operational power state commands; determining, based on the power state schedule, a period of time for the storage device to transition from a non-operational power state to an operational power state; generating transition configuration information that configures the storage device to transition from the non-operational power state to the operational power state after the storage device has been in the non-operational power state for the period of time; and providing, to the storage device, the transition configuration information to configure the storage device to transition from the non-operational power state to the operational power state prior to the storage device receiving a subsequent operational power state command, wherein the transition configuration information cause the storage device to transition to the operational power state after the storage device has been in the non-operational power state for the period of time.

In some implementations, a system comprising: a storage device; and a host system to: determine a power state schedule of the storage device, wherein the power state schedule identifies a schedule of the storage device executing operational power state commands; determine, based on the power state schedule, a period of time for the storage device to transition from a non-operational power state to an operational power state; generate transition configuration information that configures the storage device to transition from the non-operational power state to the operational power state after the storage device has been in the non-operational power state for the period of time; and provide, to the storage device, the transition configuration information to configure the storage device to transition from the non-operational power state to the operational power state prior to the storage device receiving a subsequent operational power state command, wherein the transition configuration information cause the storage device to transition to the operational power state after the storage device has been in the non-operational power state for the period of time.

In some implementations, a computer program product comprising: one or more computer-readable storage media; and program instructions stored on the one or more computer readable storage media to perform comprising: determining a power state schedule of a storage device, wherein the power state schedule identifies a schedule of the storage device executing operational power state commands; determining, based on the power state schedule, a period of time for the storage device to transition from a non-operational power state to an operational power state; generating transition configuration information that configures the storage device to transition from the non-operational power state to the operational power state after the storage device has been in the non-operational power state for the period of time; and providing, to the storage device, the transition configuration information to configure the storage device to transition from the non-operational power state to the operational power state prior to the storage device receiving a subsequent operational power state command, wherein the transition configuration information cause the storage device to transition to the operational power state after the storage device has been in the non-operational power state for the period of time.

### BRIEF DESCRIPTION OF THE DRAWINGS

FIG. 1 is a diagram of an example implementation described herein.

FIGS. 2A-2C are diagrams of an example implementation described herein.

FIG. 3 is a diagram of an example implementation described herein.

FIG. 4 is a diagram of an example computing environment in which systems and/or methods described herein may be implemented.

FIG. 5 is a diagram of example components of one or more devices of FIG. 1.

FIG. 6 is a flowchart of an example process performed by a host system.

FIG. 7 is a flowchart of an example process performed by a storage drive.

FIG. 8 is a flowchart of an example process associated with automatically transitioning from non-operational power state to operational power state based on historical data.

### DETAILED DESCRIPTION

The following detailed description of example implementations refers to the accompanying drawings. The same reference numbers in different drawings may identify the same or similar elements.

Non-volatile memory express (NVMe) is a data transfer protocol that is designed for non-volatile memory devices, such as flash storage devices and solid state drives (SSD)s. NVMe is a logical device interface that may be used for accessing the non-volatile memory devices. The non-volatile memory devices may be connected to a host system (e.g., a computer) via a Peripheral Component Interconnect Express (PCIe) bus. As used herein, an “NVMe storage device” may refer to a storage device that uses NVMe.

An NVMe storage device (also referred to as “NVME drive”) may operate in different operational power states, such as active (operational power state), idle, or sleep (non-operational power state), depending on an input/output (IO) workload. The term “workload” may be used to refer to include an amount of time and an amount of computational resources a system or network takes to complete a task or generate a particular output. As an example, the workload may be an application. In this regard, an IO workload may refer to a workload that causes read operations and/or write operations to be performed on a storage device.

In some situations, an NVMe storage device may support autonomous power state transition (APST). NVMe offers various mechanisms of power consumption minimization and host configurable power state transition mechanisms. The various mechanisms involve transitioning NVMe storage devices between different power states, such as active (operational), idle, or sleep (non-operational), depending on workload demands and input/output (IO) activity.

If an NVMe storage device supports APST feature, a controller (of the NVMe storage device) may transition to low power state or non-operational power state when the NVME storage device has not processed an IO workload for a duration of time. The duration of time may be preconfigured by the host. The NVMe storage device remains in the same state until an explicit request from the host to transition to the operational power state or an NVMe command is sent from the host to controller.

This explicit request results in significant delays in processing IO commands from the host system and results in sudden surge in power consumption for the transition of the NVMe storage device. An “IO command” may refer to a command that causes read operations and/or write operations to be performed on a storage device. A typical transition from a non-operational power state to a operational power state to service an IO workload can cause delay in range of approximately 5 ms to approximately 20 ms. The transition (from the non-operational power state to the operational power state) may be refer to as “wake up” or “waking up.”

In modern deployments with hundreds of applications interacting with multiple NVMe storage devices in parallel, a latency associated with the transition may have impact on the processing of IO commands of all the applications. The host system may experience a delay with respect to the operational command being executed. Accordingly, there is need for configuring the NVMe storage device to perform the transition in a manner that reduces the latency associated with the transition.

Implementations described herein are directed to a host-driven configuration for wake up time intervals for a storage device. In some examples, the storage device may include an NVMe storage device. A host system may communicate with the storage device to specify period of times after which the storage device is to transition from an non-operational power state to an operation power state to process IO commands without incurring in any latencies (e.g., wake up latencies). The term “operational power state” may refer to a state of high power consumption (e.g., high with respect to a power consumption threshold). The term “non-operational power state” may refer to a state of low power consumption (e.g., low with respect to the power consumption threshold).

Implementations facilitates automated efficient workload scheduling by the host system in scenarios where the host system has prior knowledge of IO usage patterns (e.g., patterns of IO workload) of the storage device. The prior knowledge may include historical transition data regarding the storage device. In some examples, the storage device may store the historical transition data in the form of log. For instance, the storage device may be configured to the historical transition data as the storage device operates.

The host system may obtain the historical transition data from the storage device and analyze the historical transition data to predict when the host system may instruct the storage device to transition to the operational power state and be ready to handle IO workloads. The historical transition data may include power state transition times of the storage device. In this regard, based on analyzing the historical transition data, the host system may identify patterns of workloads and patterns of wake up times. The patterns of workloads may refer to a frequency of perform read and/or write operations based on commands from one or more applications. For example, the patterns of workloads may refer to a frequency of the one or more applications issuing the commands. The patterns of wake up times may refer to times when the storage device transitions to the operational power state. The host system may use the power state transition times to determine subsequent transition times (e.g., wake up times) for the storage device.

The host system may communicate with the storage device to configure the transition times (or period of times after which a transition is to be performed) using a command. In some examples, the command may include an NVMe set-feature command with a new proposed feature id (e.g., 85 h—power transition timer). After expiration of a period of time (identified by the command), the storage device may transition to the operational power state from a current power state (non-operational power state or operational power state) without any additional request (or trigger) from the host system.

Implementations described herein may be directed to a format (for period of time) such that the configured transition time can be effective for one time (e.g., for a single instance or occurrence of the storage device operating in the non-operational power state) or effective for every time the storage device is operating in the non-operation power state (e.g., the lowest power state). The host system may determine different periods of time for different storage devices based on different workloads of the storage devices and different times and durations for transition between the non-operation power state and the operational power state.

Implementations described herein improve the efficiency and responsiveness of NVMe storage devices in various storage environments by allowing host systems to control their wake up times, thereby ensuring that these storage devices are ready to serve host requests with minimal latency while conserving power during idle periods. Implementations described herein also facilitate host for automated efficient workload scheduling in scenarios where the host system has prior knowledge of IO usage patterns and can predict when the host system may request the NVMe storage device to be active again and be ready to handle IO workloads. By allowing the host system to control wake-up times, implementations described herein provide a balance between power efficiency and responsiveness. The storage device remains in deep sleep for most of the time, conserving energy, and wakes up ahead to process IO commands.

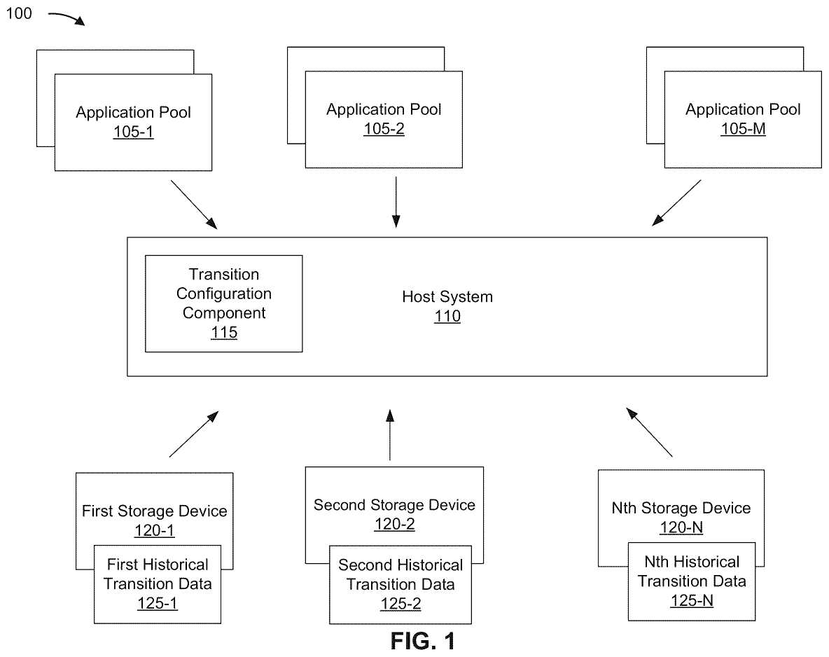

FIG. 1 is a diagram of an example implementation 100 described herein. As shown in FIG. 1, implementation 100 may include a first application pool 105-1, a second application pool 105-2, up to an mth application pool 105-m (collectively “application pools 105” and individually “application pool 105”). Implementation 100 may include a host system 110 and include a first storage device 120-1, a second storage device 120-2, up to an nth storage device 120-n (collectively “storage device 120” and individually “storage device 120”).

An application pool 105 may include multiple instances of an application. One or more instances of the application may send one or more operational power state commands, intended for a storage device 120, to host system 110. Host system 110 may forward the one or more operational power state command to the storage device 120. The term “operational power state command” may a refer to a command that causes the storage device 120 to perform an operation when the storage device 120 in an operational power state. For example, an operational power state command may include an IO command such as a command to read data stored on a storage device 120 or a command to write data to the storage device 120.

In some implementations, host system 110 may include a processing unit, such as a central processing unit, a graphics processing unit, among other examples. In some implementations, host system 110 may include a communication device and a computing device. For example, host system 110 may include a wireless communication device, a control processor system, a mobile phone, a user equipment, a laptop computer, a tablet computer, a desktop computer, and/or a similar type of device. Host system 110 may issue different commands to cause different operations to be performed on storage devices 120.

As shown in FIG. 1, host system 110 may include a transition configuration component 115. Transition configuration component 115 may include one or more components that analyze historical transition data (stored by a storage device 120) to determine a period of time after which the storage device 120 may transition from the non-operational power state to the operation power state prior receiving an operational power state command. In some implementations, transition configuration component 115 may include a machine learning model that is trained to analyze the historical transition data to determine the period of time.

The machine learning model may be implemented for use in a variety of use cases (e.g., language processing, image feature extraction, cyberthreat detection, or recommendation production), using a variety of approaches (e.g., supervised learning, unsupervised learning, or reinforcement learning), and in a variety of structures (e.g., a neural network, decision tree, linear regression, vector machine, Bayesian network, genetic algorithm, or deep learning system). The machine learning model may be trained using training data that includes different times for transition from the non-operational power state to the operation power state. The machine learning model may be trained using deep learning, supervised learning, unsupervised learning, and/or reinforcement learning. As an example, the machine learning model may include a gradient boost model.

Additionally, or alternatively, transition configuration component 115 may generate transition configuration information. The transition configuration information may identify the period of time. The transition configuration information may be used to configure the storage device 120 to transition from the non-operational power state to the operation power state after the storage device 120 has been operating in the non-operational power state for the period of time. In some implementations, the analysis of the historical transition data may be performed by one component and the transition configuration information may be generated by another component.

A storage device 120 may store data that may be used by host system 110 and/or used by an application pool 105. In some implementations, the storage device 120 may include a non-volatile memory. As an example, the storage device may include a flash storage device (or flash memory device), an SSD, among other examples. In some examples, the storage device 120 may include an NVMe storage device. In some instances, the NVMe storage device may support APST. In some implementations, the storage device may include random access memory (RAM), read-only memory (ROM), erasable programmable read-only memory (EPROM or Flash memory), static random access memory (SRAM),

The storage device 120 may be configured to store historical data regarding times at which the storage device 120 operates in the non-operational power state, times at which the storage device 120 operates in the operational power state, commands that causes the storage device 120 to transition from the non-operational power state to the operational power state, a frequency of receiving the commands, among other examples. In some examples, the historical data (referred to as “historical transition data”) may be in the form of a log. As shown in FIG. 1, first storage device 120-1 may include first historical transition data 125-1, second storage device 120-2 may include second historical transition data 125-2, and Nth storage device 120-N may include Nth historical transition data 125-N.

As indicated above, FIG. 1 is provided as an example. Other examples may differ from what is described with regard to FIG. 1. The number and arrangement of devices shown in FIG. 1 are provided as an example. There may be additional devices (e.g., a large number of devices), fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

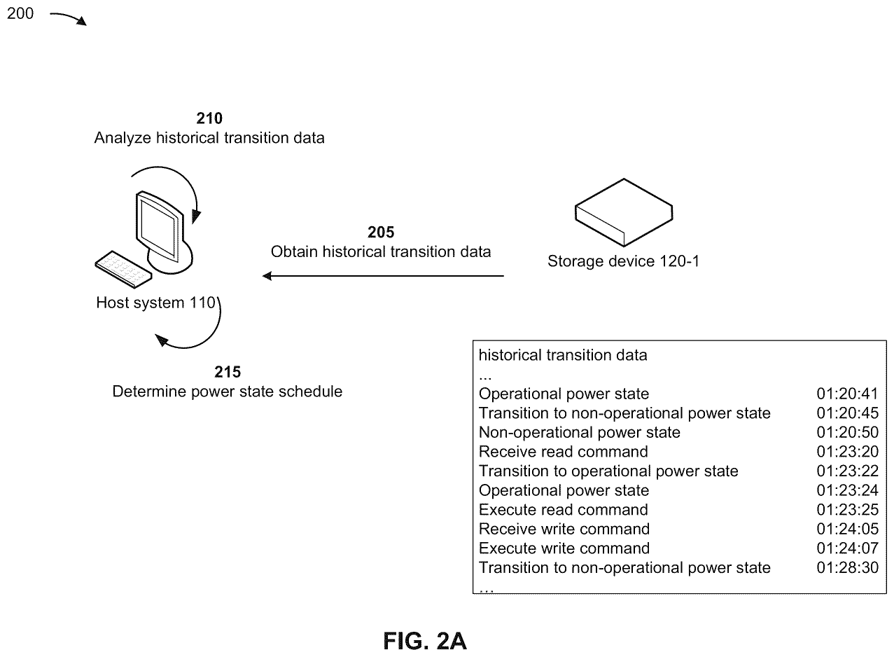

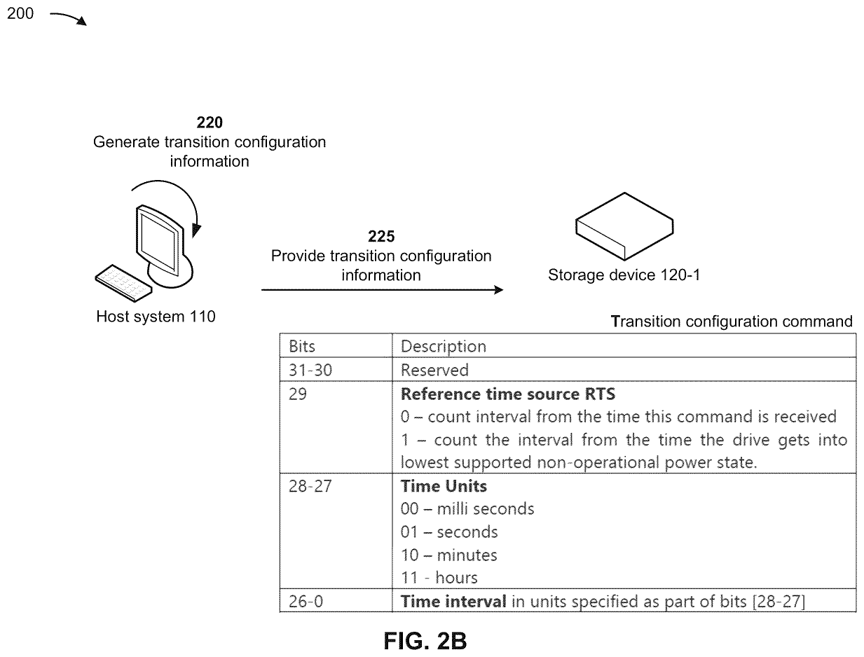

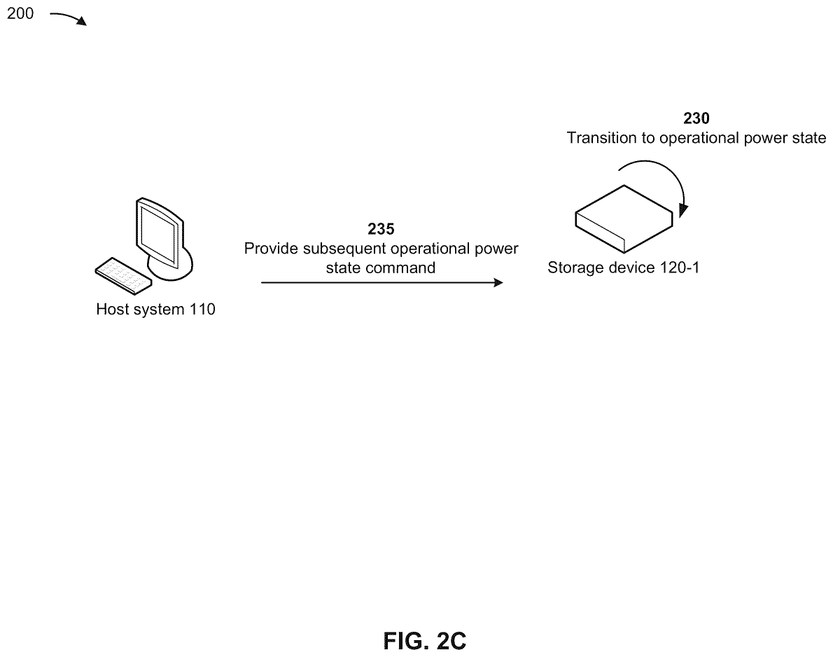

FIGS. 2A-2C are diagrams of an example implementation 200 described herein. As shown in FIGS. 2A-2C, example implementation 200 includes host system 110 and first storage device 120-1. As shown in FIG. 2A, and by reference number 205, host system 110 may obtain historical transition data. For example, host system 110 may obtain the historical transition data (e.g., first historical transition data 125-1) from first storage device 120-1. Host system 110 may use the historical transition data to determine a period of time for storage device 125-1 transitioning to the operation power state after storage device 120-1 has been in the non-operation power state. First storage device 120-1 may be configured to store the historical transition data as first storage device 120-1 operates. The historical transition data may include a log that includes information regarding different times associated with first storage device 120-1 transitioning from the non-operational power state to the operational power state.

The historical transition data may identify times when first storage device 120-1 is in the non-operational power state, a period of time during which first storage device 120-1 remains in the non-operational power state, times when first storage device 120-1 transitions from the non-operational power state to the operational power state, commands that caused first storage device 120-1 to transition from the non-operational power state to the operational power state, and times for receiving program commands, among other examples.

As shown in FIG. 2A, the historical transition data may identify a time when first storage device 120-1 operated in the operational power state, a time when first storage device 120-1 transitioned to operating in the non-operational power state, a time when first storage device 120-1 received an operational state command (e.g. a read command) that caused first storage device 120-1 to transition to the operation power state, a time when first storage device 120-1 transitioned to operating in the operational power state, and so on. In some examples, the historical transition data may be used to identify a period of time between when first storage device 120-1 operated in the operational power state and when first storage device 120-1 transitioned to operating in the non-operational power state. In some examples, the historical transition data may be used to identify a frequency of first storage device 120-1 receiving IO commands.

As shown in FIG. 2A, and by reference number 210, host system 110 may analyze historical transition data. For example, host system 110 may analyze the historical transition data to determine the period of time after which storage device 120-1 may transition to the operational power state. As discussed herein, host system 110 may use transition configuration component 115 to analyze the historical transition data. In some situations, prior to analyzing the historical transition data, host system 110 may determine whether first storage device 120-1 supports APST. Based on determining that first storage device 120-1 supports APST, host system 110 may analyze the historical transition data. As explained herein, host system 110 may analyze the historical transition data using transition configuration component 115 (e.g., using a machine learning model).

As shown in FIG. 2, and by reference number 215, host system 110 may determine a power state schedule. For example, based on analyzing the historical transition data, host system 110 may determine the period of time after which first storage device 120-1 may transition to the operational power state. In other words, based on analyzing the historical transition data, host system 110 may determine how long first storage device 120-1 may remain in the non-operational power state before transitioning to the operational power state, in anticipation of receiving IO commands. In some examples, based on analyzing the historical transition data, host system 110 may determine different times at which first storage device 120-1 is to be operating in the operational power state and different times at which first storage device 120-1 is to be operating in the non-operational power state.

As shown in FIG. 2, and by reference number 220, host system 110 may generate transition configuration information. For example, host system 110 may generate the transition configuration information based on the power state schedule. The transition configuration information may be used to configure first storage device 120-1 to transition to the operational power state after operating in the non-operational power state during the period of time. In some examples, the transition configuration information may include a new feature (e.g., a new command) associated with NVMe and/or APST.

As shown in FIG. 2B, the transition configuration information may include different portions that provide different pieces of information. For example, the transition configuration information may include a first portion (e.g., a first number of bits) that identify the period of time. In some implementations, the first portion may identify a value of the period of time (without identifying a time unit of the numerical value). In some examples, the value may include a numerical value.

As shown in FIG. 2B, the transition configuration information may include a second portion that identifies a time unit for the value identified by the first portion. For example, the second portion may indicate whether the time unit is hours, minutes, seconds, or milliseconds.

As shown in FIG. 2C, the transition configuration information may include a third portion that identifies a reference time source for the period of time. For example, the third portion may indicate whether the period of time is to start from a time when the transition configuration information is received by first storage device 120-1 or is to start from a time when first storage device 120-1 starts operating in the non-operational power state (e.g., operates in the lowest power state). In some examples, the different portions may include bits.

As shown in FIG. 2B, and by reference number 225, host system 110 may provide the transition configuration information to first storage device 120-1. For example, after generating the transition configuration information, host system 110 may provide the transition configuration information to first storage device 120-1 to configure first storage device 120-1 to transition to the operational power state based on the period of time.

As shown in FIG. 1C, and by reference number 230, first storage device 120-1 may transition to the operational power state. For example, after being configured using the transition configuration information, first storage device 120-1 may transition to operating in the operational power state after expiration of the period of time. For example, first storage device 120-1 may transition to operating in the operational power state after the period of time after receiving the transition configuration information. Alternatively, first storage device 120-1 may transition to operating in the operational power state after the period of time after operating in the non-operational power state.

As shown in FIG. 2, and by reference number 235, host system 110 may provide a subsequent operational power state command to first storage device 120-1. For example, after first storage device 120-1 has been configured using the transition configuration information, host system 110 may provide the subsequent operational power state command. The subsequent power state command may be subsequent to previous operational state commands. In some examples, host system 110 may receive the subsequent operational state command from an application (e.g., of an application pool). Because first storage device 120-1 has transitioned to operating in the operational state command, a delay associated with processing the subsequent operation state command may be minimized.

As explained herein, the host system communicates with the storage device to configure the wake-up time interval using NVMe set-feature command with a new proposed feature id (eg: 85 h—Power transition timer). the host system specifies the desired time interval after which the storage device should be in an operational power state. This is the delta time counted from the time host sends set-feature request with new proposed feature id. After expiry of this period of time, the storage device switches to operational power state from current power state (non-operational or operational state) without any further trigger from the host system.

The wake-up interval can be adjusted based on the specific requirements of the host system even if it was set already; the time configured as part of the most recent request is considered. The time interval format, described herein, is such that the configured wake up time can be effective for one time or to be effective upon every time the storage device (also referred to as “drive”) gets into lowest power state. This enables the host system to configure the storage devices to wake up at regular intervals, based on the load patterns. The host system can effectively manage power consumption as well as reduce the wake up latency as the storage device automatically switches to operational power state without explicit host requests every time.

The storage device supports the host system by retrieving the configured operational power state intervals using NVMe get-feature command with the same feature id used for configuring the operational power state intervals. The storage that supports transitioning to higher power state based on the host configured operational power state interval from whatever is the current power state (operational or non-operational power state) and is equipped with a timer mechanism that continues to run even in drive idle conditions (lowest power state) counting down the configured time interval and autonomously wakes-up the drive from its current power-state so that the drive is ready to respond to host requests without delay.

As indicated above, FIG. 2 is provided as an example. Other examples may differ from what is described with regard to FIG. 2 of devices shown in FIG. 2 is provided as an example. There may be additional devices (e.g., a large number of devices), fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices in FIG. 2.

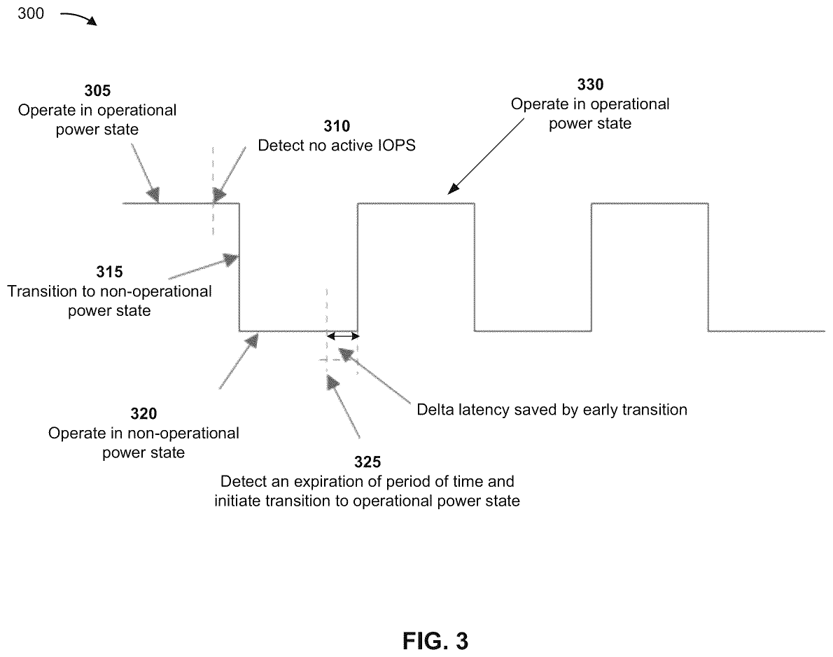

FIG. 3 is a diagram of an example implementation 300 described herein. Implementation 300 describes a process that may be implemented by first storage device 120-1 after being configured using the transition configuration information. As shown in FIG. 3, and by reference number 305, first storage device 120-1 may be operating in the operational power state. As shown in FIG. 3, and by reference number 310, first storage device 120-1 may detect no active IO operations per second (IOPS) over a particular time period. The particular time period may be determined by a user associated with host system 110.

As shown in FIG. 3, and by reference number 315, first storage device 120-1 may transition to operating in the non-operational power state based on detecting no active IOPS during the particular time period. As shown in FIG. 3, and by reference number 320, first storage device 120-1 may operate in the non-operational power state. As shown in FIG. 3, and by reference number 325, first storage device 120-1 may detect an expiration of the period of time of first storage device 120-1 operating in the non-operational power state.

As shown in FIG. 3, by transitioning to operating in the operation power state, first storage device 120-1 may reduce the latency that would have been experienced with respect to processing a command if the command had caused first storage device 120-1 to transition. As shown in FIG. 3, and by reference number 330, first storage device 120-1 may transition to operating in the operation power state prior to receiving an operation power state command, such as a read command or write command.

As indicated above, FIG. 3 is provided as an example. Other examples may differ from what is described with regard to FIG. 3 of devices shown in FIG. 3 is provided as an example. There may be additional devices (e.g., a large number of devices), fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) shown in FIG. 3 may perform one or more functions described as being performed by another set of devices in FIG. 3.

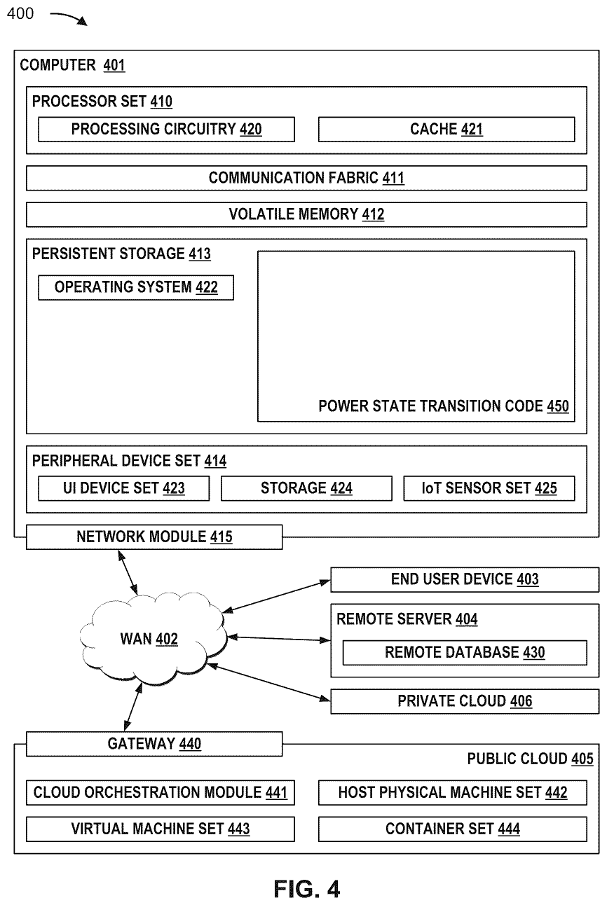

FIG. 4 is a diagram of an example computing environment 400 in which systems and/or methods described herein may be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any

suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code involved in performing the inventive methods, such as process state transition code 450. In addition to block 450, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 450, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 450 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in block 450 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401) and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

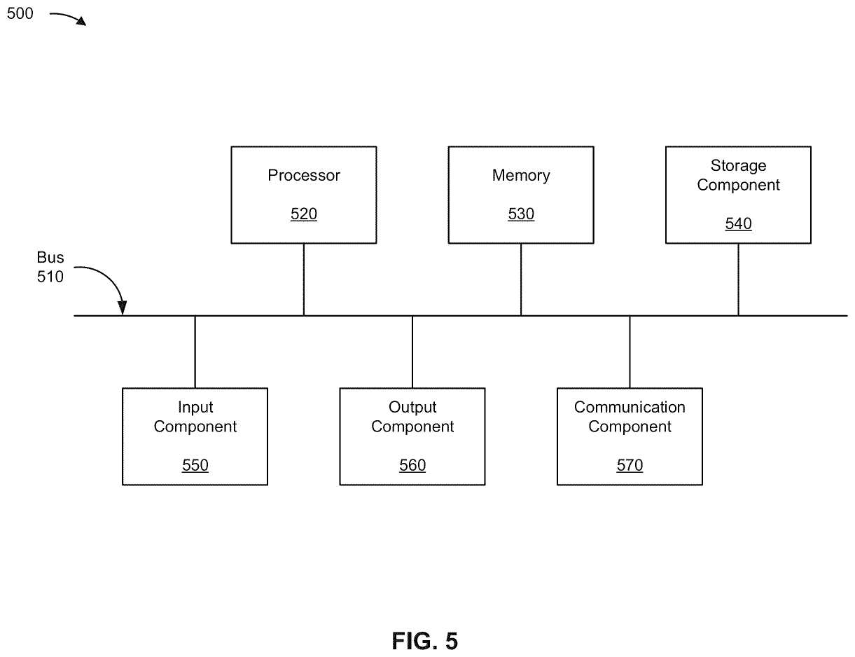

FIG. 5 is a diagram of example components of a device 500, which may correspond to host system 110 and/or first storage device 120-1. In some implementations, host system 110 and/or first storage device 120-1 may include one or more devices 500 and/or one or more components of device 500. As shown in FIG. 5, device 500 may include a bus 510, a processor 520, a memory 530, a storage component 540, an input component 550, an output component 560, and a communication component 570.

Bus 510 includes a component that enables wired and/or wireless communication among the components of device 500. Processor 520 includes a central processing unit, a graphics processing unit, a microprocessor, a controller, a microcontroller, a digital signal processor, a field-programmable gate array, an application-specific integrated circuit, and/or another type of processing component. Processor 520 is implemented in hardware, firmware, or a combination of hardware and software. In some implementations, processor 520 includes one or more processors capable of being programmed to perform a function. Memory 530 includes a random access memory, a read only memory, and/or another type of memory (e.g., a flash memory, a magnetic memory, and/or an optical memory).

Storage component 540 stores information and/or software related to the operation of device 500. For example, storage component 540 may include a hard disk drive, a magnetic disk drive, an optical disk drive, a solid state disk drive, a compact disc, a digital versatile disc, and/or another type of non-transitory computer-readable medium. Input component 550 enables device 500 to receive input, such as user input and/or sensed inputs. For example, input component 550 may include a touch screen, a keyboard, a keypad, a mouse, a button, a microphone, a switch, a sensor, a global positioning system component, an accelerometer, a gyroscope, and/or an actuator. Output component 560 enables device 500 to provide output, such as via a display, a speaker, and/or one or more light-emitting diodes. Communication component 570 enables device 500 to communicate with other devices, such as via a wired connection and/or a wireless connection. For example, communication component 570 may include a receiver, a transmitter, a transceiver, a modem, a network interface card, and/or an antenna.

Device 500 may perform one or more processes described herein. For example, a non-transitory computer-readable medium (e.g., memory 530 and/or storage component 540) may store a set of instructions (e.g., one or more instructions, code, software code, and/or program code) for execution by processor 520. Processor 520 may execute the set of instructions to perform one or more processes described herein. In some implementations, execution of the set of instructions, by one or more processors 520, causes the one or more processors 520 and/or the device 500 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 5 are provided as an example. Device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

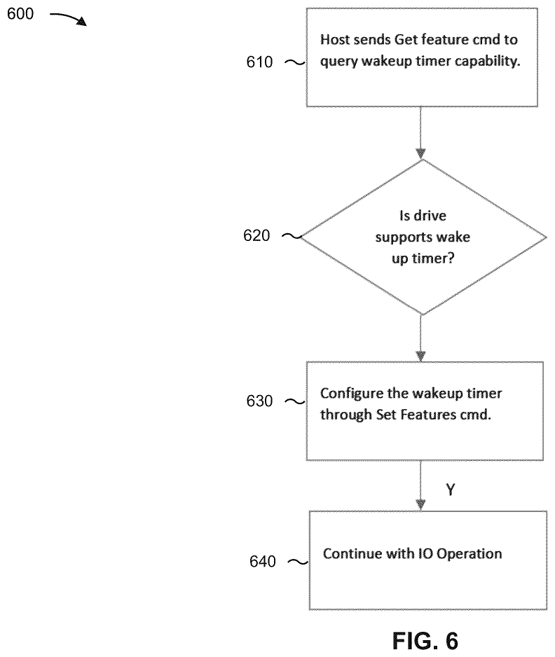

FIG. 6 is a flowchart of an example process 600 performed by a host system. In some implementations, one or more process blocks of FIG. 6 may be performed by a host system (e.g., host system 110). Additionally, or alternatively, one or more process blocks of FIG. 6 may be performed by one or more components of device 500, such as processor 520, memory 530, storage component 540, input component 550, output component 560, and/or communication component 570.

As shown in FIG. 6, process 600 may include sending a get feature command to query a wake up timer capability (block 610). For example, host system 110 may be sending the get feature command to first storage device 120-1 to determine whether first storage device 120-1 supports APST.

As further shown in FIG. 6, process 600 may include determining whether the storage device supports a wake up timer (block 620). For example, based on sending the get feature command, host system 110 may receive a response from first storage device 120-1. The response may indicate whether first storage device 120-1 supports the wake up timer. The water timer may refer to the period of time described herein.

As further shown in FIG. 6, process 600 may include configuring the wake up timer through the set features command (block 630). For example, first storage device 120-1 may be configured based the transition configuration information, as described herein.

As further shown in FIG. 6, process 600 may include continuing with IO operation (block 640). For example, after providing the transition configuration information to first storage device 120-1 to configure first storage device 120-1, as explained herein, host system 110 may continue to process IO commands.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

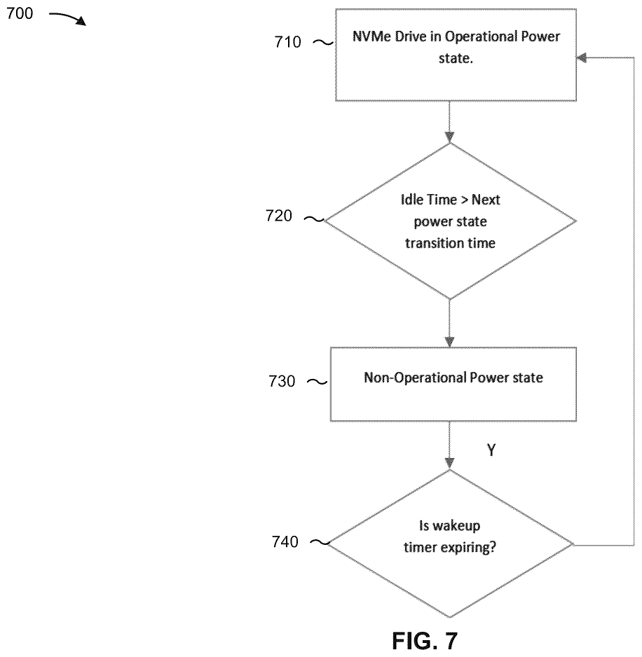

FIG. 7 is a flowchart of an example process 700 performed by a storage drive that supports APST. In some implementations, one or more process blocks of FIG. 7 may be performed by a storage device (e.g., first storage device 120-1). Additionally, or alternatively, one or more process blocks of FIG. 7 may be performed by one or more components of device 500, such as processor 520, memory 530, storage component 540, input component 550, output component 560, and/or communication component 570.

As shown in FIG. 7, process 700 may include operating in the operational power state (block 1110). For example, host system 110 may be operating in the operational power state.

As further shown in FIG. 7, process 700 may include determining whether the idle time exceeds (block 720). For example, first storage device 120-1 may determine whether no IOPS has been detected for the particular time period, as described herein.

As further shown in FIG. 7, process 700 may include transitioning to operate in the non-operational power state (block 730). For example, first storage device 120-1 may transition to operating in the non-operational power state if first storage device 120-1 has not received any operational state commands for the particular time period.

As further shown in FIG. 7, process 700 may include determining whether the wake up timer has expired (block 740). For example, after transitioning to the non-operational power state, first storage device 120-1 may determine whether the period of time has expired. If the period of time has expired, first storage device 120-1 may transition to operating in the operational power state. If the period of time has not expired, first storage device 120-1 may remain in the non-operational power state.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

[symbol]

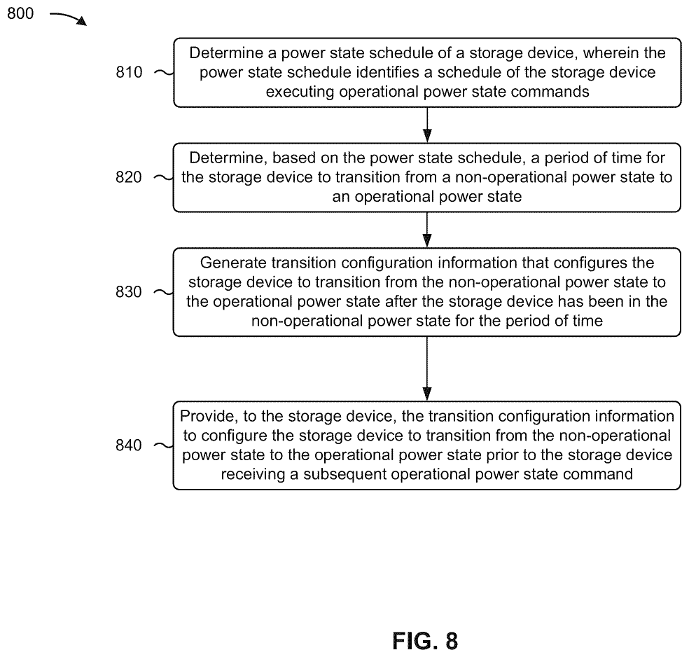

FIG. 8 is a flowchart of an example process 800 associated with automatically transitioning from non-operational power state to operational power state based on historical data. In some implementations, one or more process blocks of FIG. 8 may be performed by a by a host system (e.g., host system 110). Additionally, or alternatively, one or more process blocks of FIG. 6 may be performed by one or more components of device 500, such as processor 520, memory 530, storage component 540, input component 550, output component 560, and/or communication component 570.

As shown in FIG. 8, process 800 may include determining a power state schedule of a storage device, wherein the power state schedule identifies a schedule of the storage device executing operational power state commands (block 810). For example, the host system may determine a power state schedule of a storage device, wherein the power state schedule identifies a schedule of the storage device executing operational power state commands, as described above. In some implementations, the power state schedule identifies a schedule of the storage device executing operational power state commands.

As further shown in FIG. 8, process 800 may include determining, based on the power state schedule, a period of time for the storage device to transition from a non-operational power state to an operational power state (block 820). For example, the host system may determine, based on the power state schedule, a period of time for the storage device to transition from a non-operational power state to an operational power state, as described above.

As further shown in FIG. 8, process 800 may include generating transition configuration information that configures the storage device to transition from the non-operational power state to the operational power state after the storage device has been in the non-operational power state for the period of time (block 830). For example, the host system may generate transition configuration information that configures the storage device to transition from the non-operational power state to the operational power state after the storage device has been in the non-operational power state for the period of time, as described above.

As further shown in FIG. 8, process 800 may include providing, to the storage device, the transition configuration information to configure the storage device to transition from the non-operational power state to the operational power state prior to the storage device receiving a subsequent operational power state command, wherein the transition configuration information cause the storage device to transition to the operational power state after the storage device has been in the non-operational power state for the period of time (block 840). For example, the host system may provide, to the storage device, the transition configuration information to configure the storage device to transition from the non-operational power state to the operational power state prior to the storage device receiving a subsequent operational power state command, wherein the transition configuration information cause the storage device to transition to the operational power state after the storage device has been in the non-operational power state for the period of time, as described above. In some implementations, the transition configuration information cause the storage device to transition to the operational power state after the storage device has been in the non-operational power state for the period of time.

In some implementations, the operational power state commands include input/output (IO) commands, and wherein the subsequent operational power state command includes an IO command.

In some implementations, the storage device is a nonvolatile memory express (NVMe) storage device, and wherein the NVMe storage device supports an autonomous power states transition (APST) feature.

In some implementations, process 800 includes determining whether the NVMe storage device supports the APST feature, and determining the power state schedule based on determining whether the NVMe storage device supports the APST feature.

In some implementations, process 800 includes configuring the storage device to store historical transition data, wherein determining the power state schedule includes obtaining the historical transition data from the storage device, and determining the power state schedule based on the historical transition data.

In some implementations, the historical transition data identifies times when the storage device is in the non-operational power state, a period of time during which the storage device remains in the non-operational power state, times when the storage device transitions from the non-operational power state to the operational power state, commands that caused the storage device to transition from the non-operational power state to the operational power state, and times for receiving program commands.

In some implementations, the transition configuration information includes a first field that identifies a numerical value for the period of time and first field that identifies a unit of time for the period of time.

In some implementations, the transition configuration information indicates the period of time as beginning after the storage device receiving the transition information or as beginning after the storage device transitions to the non-operational power state.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
determining a power state schedule of a storage device,
wherein the power state schedule identifies a schedule of the storage device executing operational power state commands;
determining, based on the power state schedule, a period of time for the storage device to transition from a non-operational power state to an operational power state;
generating transition configuration information that configures the storage device to transition from the non-operational power state to the operational power state after the storage device has been in the non-operational power state for the period of time; and
providing, to the storage device, the transition configuration information to configure the storage device to transition from the non-operational power state to the operational power state prior to the storage device receiving a subsequent operational power state command,
wherein the transition configuration information cause the storage device to transition to the operational power state after the storage device has been in the non-operational power state for the period of time.

2. The method of claim 1, wherein the operational power state commands include input/output (IO) commands, and
wherein the subsequent operational power state command includes an IO command.

3. The method of claim 1, wherein the storage device is a nonvolatile memory express (NVMe) storage device, and
wherein the NVMe storage device supports an autonomous power states transition (APST) feature.

4. The method of claim 3, further comprising:
determining whether the NVMe storage device supports the APST feature; and
determining the power state schedule based on determining whether the NVMe storage device supports the APST feature.

5. The method of claim 1, further comprising:
configuring the storage device to store historical transition data,
wherein determining the power state schedule includes:
obtaining the historical transition data from the storage device, and
determining the power state schedule based on the historical transition data.

6. The method of claim 5, wherein the historical transition data identifies times when the storage device is in the non-operational power state, a period of time during which the storage device remains in the non-operational power state, times when the storage device transitions from the non-operational power state to the operational power state, commands that caused the storage device to transition from the non-operational power state to the operational power state, and times for receiving program commands.

7. The method of claim 1, wherein the transition configuration information includes a first field that identifies a numerical value for the period of time and first field that identifies a unit of time for the period of time.

8. The method of claim 1, wherein the transition configuration information indicates the period of time as beginning after the storage device receiving the transition information or as beginning after the storage device transitions to the non-operational power state.

9. A system comprising:
a storage device; and
a host system to:
determine a power state schedule of the storage device,
wherein the power state schedule identifies a schedule of the storage device executing operational power state commands;
determine, based on the power state schedule, a period of time for the storage device to transition from a non-operational power state to an operational power state;
generate transition configuration information that configures the storage device to transition from the non-operational power state to the operational power state after the storage device has been in the non-operational power state for the period of time; and
provide, to the storage device, the transition configuration information to configure the storage device to transition from the non-operational power state to the operational power state prior to the storage device receiving a subsequent operational power state command,
wherein the transition configuration information cause the storage device to transition to the operational power state after the storage device has been in the non-operational power state for the period of time.

10. The system of claim 9, wherein the host system is to:
determine whether the storage device supports an autonomous power states transition (APST) feature; and
determine the power state schedule based on determining whether the storage device supports the APST feature.

11. The system of claim 9, wherein, to determine the power state schedule, the host system is to:
obtain historical transition data from the storage device, and
determine the power state schedule based on the historical transition data.

12. The system of claim 11, wherein the historical transition data identifies times when the storage device is in the non-operational power state, a period of time during which the storage device remains in the non-operational power state, times when the storage device transitions from the non-operational power state to the operational power state, commands that caused the storage device to transition from the non-operational power state to the operational power state, and times for receiving program commands.

13. The system of claim 9, wherein the transition configuration information includes a first field that identifies a numerical value for the period of time and first field that identifies a unit of time for the period of time.

14. The system of claim 9, wherein the storage device is a nonvolatile memory express (NVMe) storage device, and
wherein the NVMe storage device supports an autonomous power states transition (APST) feature.

15. A computer program product comprising:
one or more computer-readable storage media; and
program instructions stored on the one or more computer readable storage media to perform comprising:
determining a power state schedule of a storage device,
wherein the power state schedule identifies a schedule of the storage device executing operational power state commands;
determining, based on the power state schedule, a period of time for the storage device to transition from a non-operational power state to an operational power state;
generating transition configuration information that configures the storage device to transition from the non-operational power state to the operational power state after the storage device has been in the non-operational power state for the period of time; and
providing, to the storage device, the transition configuration information to configure the storage device to transition from the non-operational power state to the operational power state prior to the storage device receiving a subsequent operational power state command,
wherein the transition configuration information cause the storage device to transition to the operational power state after the storage device has been in the non-operational power state for the period of time.

16. The computer program product of claim 15, wherein determining the power state schedule of a storage device comprises:
obtaining historical transition data from the storage device; and
determining the power state schedule based on the historical transition data.

17. The computer program product of claim 16, wherein the historical transition data identifies times when the storage device is in the non-operational power state, a period of time during which the storage device remains in the non-operational power state, times when the storage device transitions from the non-operational power state to the operational power state, commands that caused the storage device to transition from the non-operational power state to the operational power state, and times for receiving program commands.

18. The computer program product of claim 16, wherein determining the power state schedule of a storage device comprises:
determining whether the storage device supports an autonomous power states transition (APST) feature; and
determining the power state schedule based on determining whether the storage device supports the APST feature.

19. The computer program product of claim 16, wherein the transition configuration information includes a first field that identifies a numerical value for the period of time and first field that identifies a unit of time for the period of time.

20. The computer program product of claim 16, wherein the storage device is a nonvolatile memory express (NVMe) drive, and
wherein the NVMe storage device supports an autonomous power states transition (APST) feature.
